(19) United States
(12) Patent Application Publication
(10) Pub. No.: US 2009/0179765 A1
(43) Pub. Date: Jul. 16, 2009

(54) SIGNAL ADAPTATION IN RESPONSE TO ORIENTATION OR MOVEMENT OF A MOBILE ELECTRONIC DEVICE

(75) Inventors: Niels NYMARK, Hillerod (DK); Thomas Bove, Copenhagen (DK)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/351,016

(22) Filed: Jan. 9, 2009

Related U.S. Application Data
(63) Continuation of application No. 11/954,796, filed on Dec. 12, 2007.

(51) Int. Cl. G08B 21/00; H04M 1/00

(52) U.S. Cl. 340/669; 455/550.1

(57) ABSTRACT

A mobile electronic device generates a signal in response to an event in the device for informing the user of the occurrence of the event. The electronic device is provided with an orientation sensor or a movement sensor. The electronic device is configured to adapt the signal that is generated upon occurrence of an event when the device detects that the orientation of the device is changed or that the device is moved.

### FIELD

The disclosed embodiments relate to a mobile electronic device that generates a signal when an event occurs in said device in order to inform the user of the device about the occurrence of the event. In particular the invention relates to adapting, the signal that is generated to the circumstances in which the device is used.

### BACKGROUND

Mobile electronic devices, such as mobile phones inform the user of an event, such as an incoming message or phone call, by generating a signal that informs the user of the device about the occurrence an event in the device. A common way of informing the user is by generating an audible signal, an optical signal, a vibrational signal or combinations thereof. In order to easily adapt to the intensity and nature of the signal in a user-friendly manner, mobile phones are commonly provided with profiles, which are groups of settings that allow the user to change the signals associated with a group of different types of events to the circumstances in which the mobile phone is used in one step. The disadvantage of this known technology is that a user can easily forget to adapt the profile to the current circumstances, so that the phone will ring loud during a meeting. If such an undesired loud signal should occur, it requires pressing of specific buttons of the user interface to end the disturbing signal, which adds to the inconvenience.

### SUMMARY

On this background, to the aspects of the disclosed embodiments provide an electronic device that overcomes or at least reduces the drawbacks indicated above.

In one aspect, the disclosed embodiments are directed to providing a mobile electronic device configured to generate a signal upon an event in said device for informing a user of the device about the occurrence of the event, said device being provided with a movement and/or orientation sensor and said device being configured to adapt the signal in response to the orientation and/or movement of the device as detected by said movement and/or orientation sensor.

The adaptation of the signal on the basis of the information about the orientation and/or the movement of the device provides for an improved flexibility and adaptability to the circumstances in which the mobile electronic device is used. This improvement enables these devices to be used in circumstances and environments in which they otherwise could disturb or be inappropriate.

The device may be configured to adapt the intensity of the signal in response to a detected orientation or movement of the device.

The device may be configured to adapt the nature of the signal in response to a detected orientation or movement of the device.

The signal may have a visual and/or audible and/or vibrational nature.

The device and said motion sensor may be configured for determining if the device is moved as a result of the user taking the device in his or her hand and said device being configured to adapt said signal when the device detects that the user has taken the device in his/her hands.

The signal may be an audible signal with a predetermined loudness, wherein the change is a reduction in loudness of said audible signal.

The audible signal may be completely muted due to said change.

The signal may be controlled through selection of one of a plurality of profiles that are stored in the device, and wherein said signal change is effected by a change of the active profile.

The motion sensor may comprise an accelerometer.

The aspects of the disclosed embodiments are also directed to providing a method for controlling signals generated by a mobile electronic device upon an event in said device for informing a user of the device about the occurrence of the event, said method comprises monitoring a sensor signal from a movement and/or orientation sensor in said device and adapting the signal in response to the orientation and/or movement of the device as sensed by said movement and/or orientation sensor.

The method may further comprise adapting the intensity of the signal in response to a sensed orientation or movement of the device.

The method may further comprise adapting the nature of the signal in response to a sensed orientation or movement of the device.

The signal may have a visual and/or audible and/or vibrational nature.

The method may further comprise determining if the device is moved as a result of the user taking the device in his or her hand adapting said signal when it has been determined that the user has taken the device in his/her hands.

The signal may be controlled though selection of one of a plurality of profiles that are stored in the device, further comprising adapting signal change by changing the active profile.

Aspects of the disclosed embodiments are also directed to providing a computer readable medium including at least computer program code for controlling a mobile electronic device that is provided with a movement and/or orientation sensor, said computer readable medium comprising software code for generating signal upon an event in said device for informing a user of the device about the occurrence of the event, software code for detecting the orientation and/or movement of the device, and software code for adapting the signal in response to the orientation and/or movement of the device as detected by said movement and/or orientation sensor.

In one aspect, the disclosed embodiments provide a mobile electronic device with an improved control over enabling the user interface for input after the user interface has been disabled. This object is achieved by providing a mobile electronic device with a user interface that can be manually or automatically disabled for user input, said device being provided with a sensor for determining if the device is moved as a result of the user taking the device in his or her hand, said device being configured to enable at least portion of said user interface for user input upon an event in said device when the device detects that the user has taken the device in his/her hands.

The use of information from an orientation and/or movement sensor to control the enablement of elements of the user interface for user input provides for improved security against inadvertent input and thereby increases user confidence in the device.

The portion of the user interface that is enabled is preferably related to the nature or type of event.

Further aspects, features, advantages and properties of the touchpad, method and computer readable medium according to the invention will become apparent from the detailed description.

### BRIEF DESCRIPTION OF THE DRAWINGS

In the following detailed portion of the present description, the disclosed embodiments will be explained in more detail with reference to the exemplary embodiments shown in the drawings, in which:

FIG. 1 is a plane front view of a mobile phone with a touchpad according to an embodiment,

FIG. 2 is a block diagram illustrating the general architecture of a mobile phone of FIG. 1 in accordance with aspects of the disclosed embodiments,

FIG. 3 is a flow chart of a method according to an embodiment of the invention, and

FIGS. 4 to 6 form a collection of plane views showing screenshots illustrating the operation of the device shown in FIG. 1.

### DETAILED DESCRIPTION OF PREFERRED EMBODIMENTS

In the following detailed description, the mobile electronic device, the method and the software product according to the invention in the form of a cellular/mobile phone will be described by the preferred embodiments.

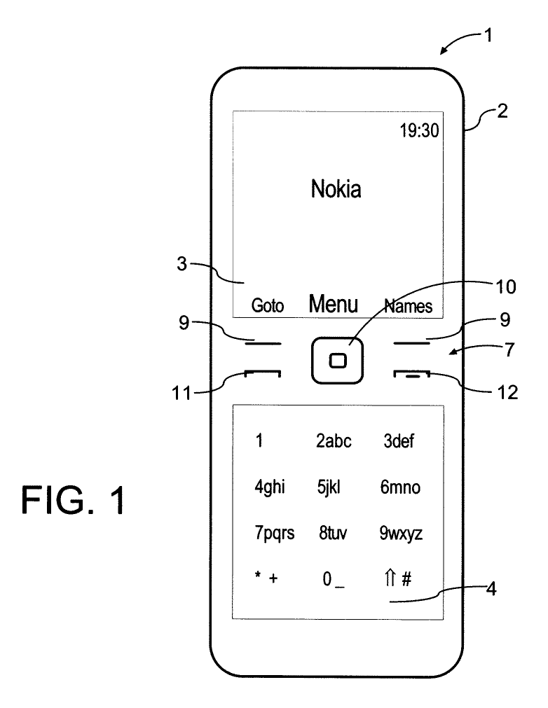

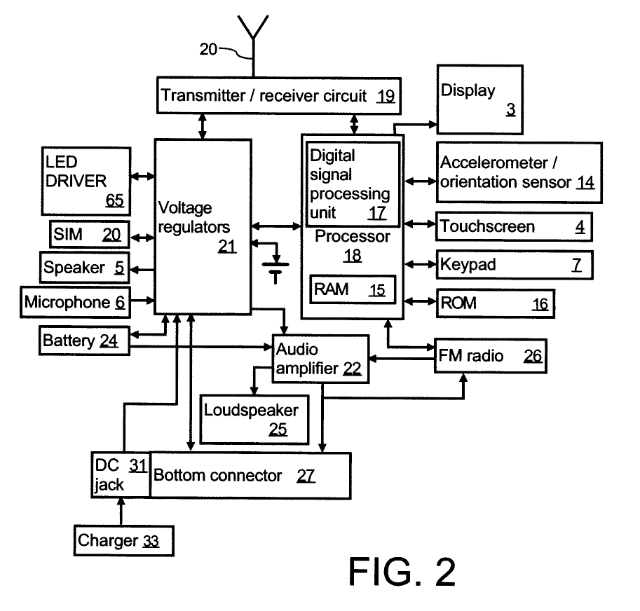

FIG. 1 illustrates a first embodiment of a mobile terminal according to the invention in the form of a mobile telephone 1 by a front view. The mobile phone 1 comprises a user interface having a housing 2, a touch screen 3, a mechanical on/off button (not shown), a speaker 5 (FIG. 2), and a microphone 6 (FIG. 2). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

Non vocal user input is mainly via a conventional display screen 3, a mechanical keypad 7 with discrete mechanical keys 9,10,12,12 and a touchscreen 4. The touch screen can be operated by the user touching it with his/her finger(tip). The flat display 3 is typically made of an LCD with back lighting, such as a TFT matrix capable of displaying color images. The touch screen 4 is of a similar construction with a touch sensitive layer disposed on top of the LCD display. In an embodiment (not shown) the display screen 3 is also configured as a touchscreen that can be used for user input. Also the keypad 7 may in an embodiment (not shown) be constructed with touch sensitive keys.

The touchscreen 4 is used for displaying a virtual numerical keypad for dialing phone numbers, displaying a virtual keyboard for entering text and displaying icons or textual items for selecting functions and programs, with the content of the touchscreen 4 being determined by the mode of the mobile phone 1. The mechanical keypad 7 includes a four-way navigation plus select key 10 that is used for navigation and for selection of the function indicated in the label in the display screen 3 above the navigation key 10, the left soft key 9 and the right softkey 9 that are used for selecting function indicated in the respective label in the display screen 3 above the soft keys 9. Call handling is performed with an off hook key 11 for accepting incoming calls and for initiating a new call and the on hook key 12 is used for rejecting incoming calls and for ending ongoing calls. The labels above the soft keys 9 and above the navigation key 10 are adapted to the current mode of the phone. In the idle mode that is shown in FIG. 1 the mobile phone 1 is ready for the entry of a phone number using the virtual keypad shown on the touchscreen 4. The left soft key 9 is ready for selecting one of a plurality of shortcuts, the navigation key 10 is ready for selecting an entry into the menu structure and the right soft key 9 is ready for entering the phone book (contact list). As soon as the user dials a number the labels above these keys will change to show relevant functions in accordance with the new mode of the mobile phone 1, in a manner well known for existing mobile phones from Nokia Corporation. The user-interface elements on the touchscreen 4 also change in accordance with the mode of the mobile phone 1 to provide the best input possibilities in accordance with the mode of the phone. Thus, as an example the touch screen 4 can in embodiment show a keypad with letters only, i.e. a keyboard similar to a QWERTY keyboard. The keyboard is of course adapted to the current writing language that is being used in the mobile phone 1.

A releasable rear cover (not shown) gives access to the SIM card 20 (FIG. 2), and the battery pack 24 (FIG. 2) in the back of the phone that supplies electrical power for the electronic components of the mobile phone 1.

FIG. 2 illustrates in a block diagram form the general architecture of a mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 65 (for the LEDS backlighting the keypad 7, and in some embodiments below the (touchpad), the SIM card 20, battery 24, the bottom connector 27, the DC jack 31 (for connecting to the charger 33) and the audio amplifier 33 that drives the (hands-free) loudspeaker 25.

The processor 18 also forms the interface for some of the peripheral units of the device, including a Flash ROM memory 16, the display screen 3, the touch screen 4, the mechanical keypad 7, an accelerometer and/or orientation sensor 14 and an FM radio 26.

The touchscreen 4 is configured to provide one or more control functions for controlling various applications associated with the mobile phone 1 or other type of mobile electric device. For example, the touch initiated control function may be used to move an object or perform an action on the touchscreen 3 or to make selections or issue commands associated with operating the mobile phone 1. Normally, the touchscreen is arranged to receive input from a finger pressing on- or moving over the surface of the touchpad in order to implement the touch initiated control function.

The touchscreen 4 can be disabled by the user through the activation of a particular sequence of key presses, such as for example pressing the right soft key 9 within a certain time interval after pressing the left soft key 9. Alternatively, the disablement of the touchscreen 4 can be triggered by a timeout when the user interface has not been active for a predetermined time interval. The touchscreen 4 is disabled to avoid inadvertent input when the device 1 is not in use, for example when the mobile phone 1 is placed in a pant pocket or in a bag. When the touchscreen 4 is disabled, the input via the mechanical keypad seven is in an embodiment limited to those key that are used in a keypress sequence to enable the touchpad 4 and the mechanical keypad 7.

Upon various events in the mobile phone 1 the mobile phone generates a signal to inform the user of the event. Examples of such events are incoming messages, incoming phone calls, a warning for low battery level, a download being completed, and any other events that the user may wish to be informed about. The signal may have an audible and/or vibrational and/or visual form. For example an incoming call is signaled by a ringing tone in combination with a vibration signal. In an embodiment the form of signaling for the respective events is user adjustable. These settings may be individually set or by using groups of settings that are generally referred to as profiles.

When an event is detected, the processor 18 will start generating the signal that is associated with the event concerned. Simultaneously, the processor 18 monitors the signal from the accelerometer and/or orientation sensor 14. When the processor 18 detects that a given predetermined orientation of the mobile phone 1 is assumed or that the mobile phone has made a particular type or form of movement the processor 18 adapts the signal that is being generated to a new signal that has been predetermined and is associated with the detected orientation or type or form of movement.

The processor 18 can in an embodiment be configured to mute a ringing tone when the mobile phone 1 is placed with the side houses the display screen three and the touch screen 4 down (i.e. The mobile phone 1 is placed face down). Other orientations of the mobile phone 1 may have other changes of the signal concerned associated therewith. The change does not need to be a meeting of an audible signal. The change could be a change of the type of signal, for example from a ringing tone to an optical signal in which the backlighting or other light emitting elements of the user interface is flashed. Other examples are a change to a lower intensity of the signal that is being generated or vice versa. The change does not need to be triggered by a particular orientation, but can also be triggered by a particular movement or type of movement.

In an embodiment the processor 18 is configured to deduct from the signal of the accelerometer and/or orientation sensor 14 that the mobile phone is being picked up by the user, i.e. in a situation in which the phone has been resting on a tabletop or the like and a signal is issued upon an event in the mobile phone 1 and the user has thereupon taken the mobile phone 1 in his/her hands, the processor 18 is able to deduct this change in the movement pattern of the mobile phone 1 and is able to conclude that user has picked up the phone 1 in response to the signal. Thereupon, the processor 18 adapts the signal in accordance with a preprogrammed type of change of signal associated with this type of event and detected movement pattern. In a similar fashion the processor 18 is able to conclude that the mobile phone 1 has been taken out of a bag or taken out of a pant pocket and is held in the hands of user. As stated before, that type of change can be fixed by the manufacturer or be adjustable by the user. In an embodiment in the processor 18 will mute a ringing tone when the user picks up the phone 1 after an incoming call is a signaled. Thus, when the user grabs his/her phone 1 upon an incoming call when he/she is in a group of people or near other people, he/she can take his/her phone and thereby silence the ringing tone in order not disturb the surrounding people, walk away to create a distance to the people in the vicinity and first thereupon answer the call so that the call can be carried out in privacy.

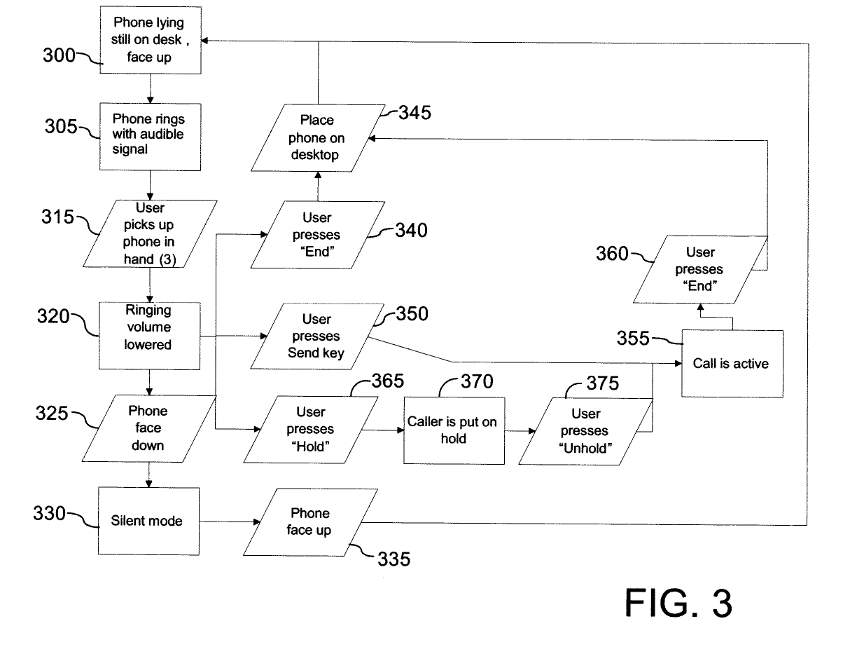

FIG. 3 illustrates an embodiment of the invention by means of a flowchart. In block 300 the mobile phone 1 is placed face up on a desktop or the like. In block 305 an incoming call is detected and an audible signal is generated, such as a ringing tone. In block 315 the user picks up the phone in his/her hand. In block 320 the processor 18 lowers the ringing volume.

Thereupon, the user has several possibilities.

If the user places the mobile phone one face down in block 325 the ringing signal is completely muted in block 330. After the user puts the mobile phone 1 face up again in block 335 the process returns to block 300.

If the user presses the “end” (on hook key 12) in block 340 the call is rejected and after the user places the mobile phone 1 back on the desktop in block 345 so that the process returns to block 300.

If the user presses the “send key” (off hook key 11) in block 350 the call is answered and in block 355 the call is active. At the end of the call the user presses the “end” (on hook key 12) in block 360 and the process moves to block 345.

If the user presses the “hold” key (navigation key 10) in book 365 the call was put on hold in book 370 until the user presses “Unhold” (as navigation key 10). Subsequently, the process moves to block 355 and the call is active.

If the user takes the phone face down before any incoming call is detected, there will in an embodiment not be any signal generated upon an incoming call. The fact that a call has been missed may be displayed in one of the displays 3,4.

According to an embodiment of the invention the signal of the accelerometer and/or orientation sensor is used to control the enablement of the touchscreen or touchscreens and the keypad 7 after input from these user-interface elements has been barred, i.e. after these elements of the user interface has been disabled. As described above, the disablement of the input elements of the user interface, in particular to those elements of the user interface that have touch sensitivity, can be performed automatically or by the user for avoiding in inverted input.

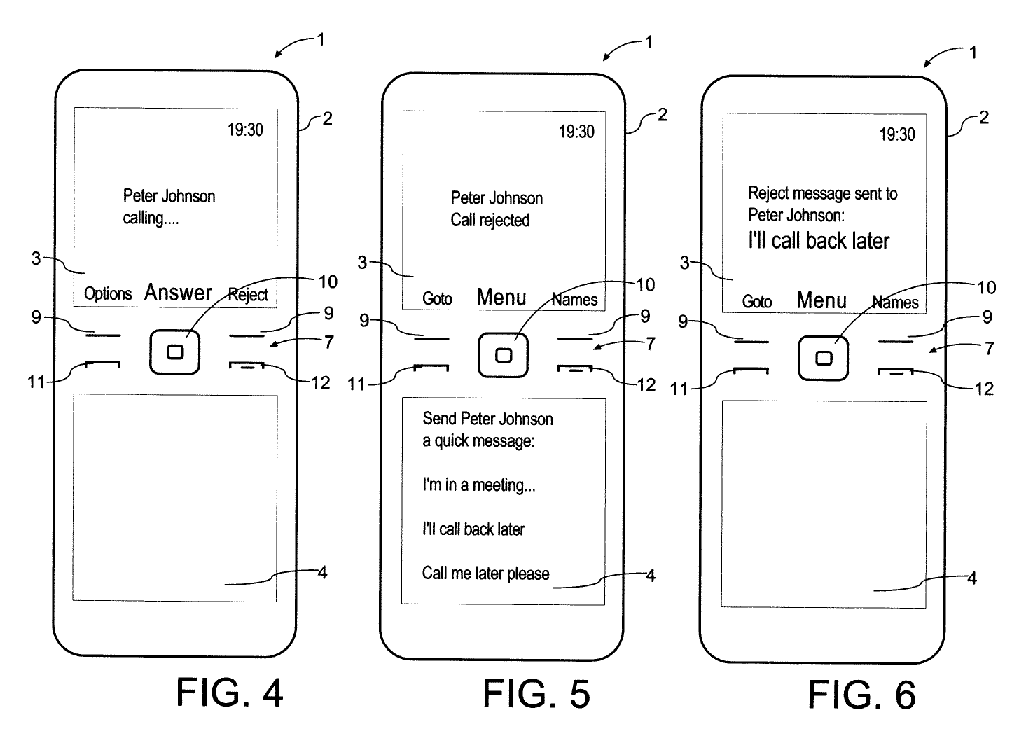

Whilst the user interface elements are disabled the processor 18 monitors the signal from the accelerometer and/or orientation sensor 14 and determines whether a predetermined orientation has been assumed or a predetermined movement or type of movement of the mobile phone 1 has occurred. If this condition is fulfilled the processor 18 enables the user interface for user input via touch or by pressing keys. This enablement may take the form of a partial enablement, in which only selected elements of user interface are enabled or take the form of a complete enablement in which all the input elements of user interface are enabled. The enablement may also be conditional on the occurrence of a particular event. Thus, in an embodiment of the call handling related keys (softkeys, hard keys or virtual keys) will be enabled when an incoming call is being detected and it has been detected that the user has taken the mobile phone in his/her hands. The process of this embodiment of the invention is illustrated by FIGS. 4 through six that show front views of the mobile electronic device according to an embodiment of the invention including information on the two display screens. In FIG. 4, an incoming call has been detected, and the mobile phone 1 signals this event by showing corresponding information on the upper display screen 3 and by playing a ringing tone. Subsequently, the processor 18 has detected via the orientation and/or motion sensor 14 that the user has taken the mobile phone 1 in his/her hands, has activated the back lighting behind the keys to the keypad 7 and behind the upper display 3 and enabled the keys of the keypad 7. None of the other elements of the user interface that can be used for user input like the touchscreen 4 have been enabled in this mode of the mobile phone 1. Further, the processor 18 displays information about the incoming call in the upper display 3 and has labeled the soft keys 9 and the navigation key 10 with appropriate labels for the current mode of the mobile phone 1. Preferably, all active elements of the mobile phone 1 have their backlighting on when they are enabled. Before the detection of the incoming call all backlighting was off and all of the user elements that can be used for user input like the touch screens 3 and 4 and the keys of the keypad 7 were disabled.

If the user decides to reject the call by pressing the right soft key 9 or by pressing the on hook key 12 the phone change to the state shown in FIG. 5. The call rejection is shown in the upper touchscreen 3 and the lower touchscreen 4 has been activated and shows a list of quick messages (e.g. SMS messages) that the user can send by pressing any of the listed messages on the lower touchscreen 4. If the user does not press any of the messages in the lower touchscreen 4 the phone will return to the idle mode and after a timeout the mobile phone 1 may in an embodiment go to a sleep mode. If the user presses one of the messages listed on the touchscreen 4 the phone 1 moves to the mode that is shown in FIG. 6. In this example the user has pressed the message “I'll call back later” and the fact that the rejection message has been sent to the caller is displayed in the upper touchscreen 3. In this mode the lower touchscreen 4 is deactivated and after a timeout to the phone 1 moves back to the idle mode.

The various aspects of the invention described above can be used alone or in various combinations. The invention is preferably implemented by a combination of hardware and software, but can also be implemented in hardware or software. The invention can also be embodied as computer readable code on a computer readable medium. It should be noted that the invention is not limited to the use with an accelerometer or an orientation sensor, any other type of sensor that is capable of determining that the mobile electronic device has assumed a given position or capable of determining that the mobile electronic device has made a certain type of movement can be used for the present invention.

The invention has numerous advantages. Different embodiments or implementations may yield one or more of the following advantages. It should be noted that this is not an exhaustive list and there may be other advantages, which are not described herein. One advantage of the invention is that signals to the user can be adapted to circumstances in a better manner than possible before. Another advantage of the invention is that the user is able to reduce the amount of disturbance of a signal simply by grabbing his/her phone. Yet another advantage of the invention is that the user can easily silence his/her phone by placing it facedown. Another advantage of the invention is that enablement of the user interface for user input (deactivating keylock) can be better controlled and is less likely to occur inadvertently.

Although the disclosed embodiments have been described in detail for purpose of illustration, it is understood that such detail is solely for that purpose, and variations can be made therein by those skilled in the art without departing from the scope of the invention.

For example, although the invention has been described in terms of a mobile phone, it should be appreciated that the invention may also be applied to other types of electronic devices, such as cameras, video recorders, music players, palmtop computers and the like. It should also be noted that there are many alternative ways of implementing the methods and apparatuses of the present invention. For example, although the touchscreen has been described in terms of being actuated by a finger, it should be noted that other objects may be used to actuate in some cases. For example, a stylus or other object may be used in some configurations of the touchpad.

The term “comprising” as used in the claims does not exclude other elements or steps. The term “a” or “an” as used in the claims does not exclude a plurality. The single processor or other unit may fulfill the functions of several means recited in the claims.

1. A mobile electronic device configured to generate a signal upon an event in said device for informing a user of the device about the occurrence of the event, said device being provided with a movement and/or orientation sensor and said device being configured to adapt the signal in response to the orientation and/or movement of the device as detected by said movement and/or orientation sensor.

2. A mobile electronic device according to claim 1, wherein said device is configured to adapt the intensity of the signal in response to a detected orientation or movement of the device.

3. A mobile electronic device according to claim 1, wherein said device is configured to adapt the nature of the signal in response to a detected orientation or movement of the device.

4. A mobile electronic device according to claim 3, wherein the signal has a visual and/or audible and/or vibrational nature.

5. A mobile electronic device according to claim 1, wherein said device and said motion sensor are configured for determining if the device is moved as a result of the user taking the device in his or her hand and said device being configured to adapt said signal when the device detects that the user has taken the device in his/her hands.

6. A mobile electronic device according to claim 1, wherein said signal is an audible signal with a predetermined loudness and wherein the change is a reduction in loudness of said audible signal.

7. A mobile electronic device according to claim 1, wherein said audible signal is completely muted due to said change.

8. A mobile electronic device according to claim 1, wherein said signal is controlled though selection of one of a plurality of profiles that are stored in the device, and wherein said signal change is effected by a change of the active profile.

9. A mobile electronic device according to claim 1, wherein said motion sensor comprises an accelerometer.

10. A method for controlling signals generated by a mobile electronic upon an event in said device for informing a user of the device about the occurrence of the event, said method comprises monitoring a sensor signal from a movement and/or orientation sensor in said device and adapting the signal in response to the orientation and/or movement of the device as sensed by said movement and/or orientation sensor.

11. A method according to claim 10, further comprising adapting the intensity of the signal in response to a sensed orientation or movement of the device.

12. A method according to claim 10, further comprising adapting the nature of the signal in response to a sensed orientation or movement of the device.

13. A method according to claim 12, wherein the signal has a visual and/or audible and/or vibrational nature.

14. A method according to claim 12, further comprising determining if the device is moved as a result of the user taking the device in his or her hand adapting said signal when it has been determined that the user has taken the device in his/her hands.

15. A method according to claim 12, wherein said signal is controlled though selection of one of a plurality of profiles that are stored in the device, further comprising adapting signal change by a changing the active profile.

16. A mobile electronic device with a user interface that can be manually or automatically disabled for user input, said device being provided with movements and/or orientation sensor, said device being configured to enable at least a portion of the disabled user interface for user input when the device detects that the device has assumed a predetermined position or has made a predetermined movement or type of movement.

17. A device according to claim 16, further configured to determine if the device is moved as a result of the user taking the device in his or her hand.

18. A device according to claim 16, further to enable at least a portion of the disabled user interface upon an event in said device is a further condition.

19. A device according to claim 16, wherein said portion of the user interface that is enabled is related to the nature or type of event.

20. A computer readable medium stored in a memory including at least computer program code for controlling a mobile electronic device that is provided with a movement and/or orientation sensor, said computer readable medium comprising:
software code for generating signal upon an event in said device for informing a user of the device about the occurrence of the event,
software code for detecting the orientation and/or movement of the device, and
software code for adapting the signal in response to the orientation and/or movement of the device as detected by said movement and/or orientation sensor.

21. A computer readable medium including at least computer program code for controlling a mobile electronic device that is provided with a user interface and a movement sensor, said computer readable medium comprising:
software code for manually or automatically disabling user input via said user interface,
software code for enabling at least portion of said user interface for user input upon an event in said device upon detection of movement that corresponds to a user taking the mobile electronic device in his/her hands.
